(19) United States
(12) Patent Application Publication
(10) Pub. No.: US 2026/0118617 A1
(43) Pub. Date: Apr. 30, 2026

(54) COHERENT FIBER OPTIC BREAKOUT CABLE ASSEMBLY AND METHOD FOR FABRICATING SAME

(71) Applicant: CORNING RESEARCH & DEVELOPMENT CORPORATION, Corning, NY (US)

(72) Inventors: Qi Wu, Painted Post, NY (US); Lei Yuan, Painted Post, NY (US)

(21) Appl. No.: 19/364,550

(22) Filed: Oct. 21, 2025

Related U.S. Application Data
(60) Provisional application No. 63/713,837, filed on Oct. 30, 2024.

(51) Int. Cl. G02B 6/44

(52) U.S. Cl. CPC G02B 6/4472; G02B 6/4479

(57) ABSTRACT

A coherent fiber optic bundle breakout cable assembly includes a trunk fiber bundle having a plurality of optical fibers in a close-packed 2D array at a trunk connector end face, and multiple breakout bundles emanating from the trunk fiber bundle and each including a group of optical fibers in a close-packed 2D array at a breakout connector end face, with optical fibers being in lateral contact with one another. Bonding material is arranged in interstitial spaces of optical fibers near ends of each breakout bundle. A method for fabricating such an assembly includes holding the plurality of optical fibers within an elastomeric fixture, dicing the plurality of fibers to provide diced ends thereof, selectively applying and curing bonding material in interstitial spaces between optical fibers proximate to the diced ends according to a bundle-forming pattern, separating groups of optical fibers into breakout bundles, and retaining each breakout bundle in a corresponding breakout bundle ferrule aperture of one or more breakout bundle ferrules.

### PRIORITY APPLICATIONS

This application claims the benefit of priority of U.S. Provisional Application Ser. No. 63/713,837 filed on Oct. 30, 2024, the content of which is relied upon and incorporated herein by reference in its entirety.

### BACKGROUND

This disclosure relates generally to optical fibers, and more particularly to coherent fiber optic cable breakout assemblies for two-dimensional arrays of optical fibers, and methods for fabricating such fiber optic cable breakout assemblies.

Optical fibers are useful in a wide variety of applications, including the telecommunications industry for voice, video, and data transmission. An exemplary coated optical includes a glass core, glass cladding surrounding the glass core, and a polymer coating (optionally including multiple coating layers) surrounding the glass cladding. An outer diameter of a coated optical fiber may be about 200 μm, about 250 μm, or any other suitable value, while a core diameter of a single-mode optical fiber may be on the order of 8 μm to 10 μm, and a core diameter of a multi-mode optical fiber may be somewhat larger. An additional covering, which may be embodied in a tight buffer layer or a loose tube (also known as a furcation tube or fanout tube), may be applied to one or more coated optical fibers to provide additional protection and allow for easier handling.

In a telecommunications system that uses optical fibers, there are typically many locations where fiber optic cables that carry the optical fibers connect to equipment or other fiber optic cables. To conveniently provide these connections, optical connectors are often provided on the ends of fiber optic cables. Many different types of optical connectors exist, including multi-fiber optical connectors. One example is the multi-fiber push on (MPO) connector having up to 24 optical fibers (e.g., received in two rows of twelve micro-holes defined in a ferrule), with a MPO connector incorporating a mechanical transfer (MT) ferrule being standardized according to TOA-604-5 and IEC 61754-7.

The rapid advances of generative artificial intelligence (AI) in recent years continues to push the size of training models, which double in size roughly every 4 months and require ever-increasing amounts of computing power. Faster graphic processing units (GPUs) and larger GPU clusters are required for high performance computing including generative AI, and the networks connecting GPUs need to support unprecedented bandwidth growth.

Existing pluggable optical transceivers and co-packaged optics for Ethernet networks entail high power consumption on-par with direct attach copper cable (DAC), which is about 5 pJ/bit. Highly parallel optical interconnects using VCCSEL or micro-LED array transceivers operating at lower speeds of about 25 Gb/s per channel have demonstrated much lower power consumption of 1 pJ/bit. Such interconnects require more optical fibers for the same total capacity as compared Ethernet optics, which currently operate at about 100 Gbps or 200 Gbps per lane. Furthermore, optical fibers connecting transmitter arrays to receiver arrays do not require breakouts. It would be highly desirable for fiber bundles to keep the relative positions on both ends so that each transmitter in a transmitter array is connected to a known element in a receiver array. Fiber bundles that are ordered in this respect are referred to as “coherent,” with a one-to-one correspondence concerning the arrangement of input and output fibers.

As optics become tightly integrated with electronic integrated circuits to decrease power consumption, higher bandwidth density is required for optical interconnects. Moving from point-to-point interconnects to point-to-multi-point interconnects can improve density and also consolidate cables.

Making coherent bundle cables with breakouts is more challenging than making conventional trunk cables, in which optical fibers are colored and grouped into ribbons or subunits. Fiber bundle cables rely solely on coherence for fiber identification in order to be cost effective. A fiber bundle typically includes hundreds or even thousands of fibers. To manually separate optical fibers of a trunk fiber bundle one-by-one into many breakout bundles while maintaining coherence would be slow and impractical process. Although it is conceivable to mount groupings of optical fibers in precision mechanical faceplates to form breakout bundles, the presence of internal support structures (i.e., faceplates) for each subunit would inevitably reduce bandwidth density.

Need exists in the art for improved coherent fiber optic cable breakout assemblies for two-dimensional arrays of optical fibers, and methods for fabricating such assemblies, that address limitations associated with conventional assemblies and fabrication methods.

### SUMMARY

The present disclosure includes coherent fiber optic bundle breakout cable assemblies each comprising a trunk fiber bundle having a plurality of optical fibers in a close-packed 2D array at a trunk connector end face, and multiple breakout bundles emanating from the trunk fiber bundle and each including a group of optical fibers in a close-packed 2D array at a breakout connector end face. In the trunk fiber bundle and each breakout bundle, optical fibers are in lateral contact with one another (e.g., along glass cladding surfaces, or along surface of hard precision coating materials). Bonding material is arranged in interstitial spaces of optical fibers near ends of each breakout bundle. For each breakout bundle, optical fibers at a breakout connector end face are mapped to a set, or a pair of subsets, of optical fibers of the trunk fiber bundle that are contiguous at the trunk connector end face. A method for fabricating such an assembly includes holding the plurality of optical fibers within an elastomeric fixture, dicing the plurality of fibers to provide diced ends thereof, selectively applying and curing bonding material in interstitial spaces between optical fibers proximate to the diced ends according to a bundle-forming pattern, separating groups of optical fibers into breakout bundles, and retaining each breakout bundle in a corresponding breakout bundle ferrule aperture of one or more breakout bundle ferrules.

One aspect of the disclosure relates to a coherent fiber optic bundle breakout cable assembly that comprises a trunk fiber bundle comprising a plurality of optical fibers in a close-packed two-dimensional array configuration at a trunk connector end face, wherein each optical fiber of the plurality of optical fibers is arranged in lateral contact with multiple other optical fibers of the plurality of optical fibers at the trunk connector end face. The coherent fiber optic bundle breakout cable assembly further comprises a plurality of breakout bundles emanating from the trunk fiber bundle, wherein each breakout bundle of the plurality of breakout bundles comprises a group of optical fibers in a close-packed two-dimensional array configuration at a breakout connector end face, and within each breakout bundle, each optical fiber of the group of optical fibers is arranged in lateral contact with multiple other optical fibers of the group of optical fibers at a breakout connector end face. For each breakout bundle of the plurality of breakout bundles, each optical fiber of the group of optical fibers comprises an end along the breakout connector end face, with bonding material arranged in interstitial spaces between at least some optical fibers of the group of optical fibers proximate to the breakout connector end face. Additionally, for each breakout bundle of the plurality of breakout bundles, the optical fibers at the breakout connector end face are mapped to a subset, or pair of subsets, of optical fibers of the trunk fiber bundle that are contiguous at the trunk connector end face.

In certain embodiments, the trunk fiber bundle comprises a trunk marker fiber along a perimeter of the trunk fiber bundle, with the trunk marker fiber comprising a marked coating at least at a location proximate to the trunk connector end face, and with the trunk marker fiber being omitted from the plurality of breakout bundles.

In certain embodiments, each breakout bundle of the plurality of breakout bundles comprises a breakout bundle marker optical fiber comprising a marked coating at least at a location proximate to the breakout connector end face, with the breakout bundle marker optical fiber being indicative of breakout bundle polarity.

In certain embodiments, for each breakout bundle of the plurality of breakout bundles, the group of optical fibers is arranged in a hexagonal close-packed configuration or a rectangular close-packed configuration.

In certain embodiments, the plurality of optical fibers of the trunk fiber bundle is arranged in a hexagonal close-packed configuration or a rectangular close-packed configuration

In certain embodiments, wherein optical fibers of the plurality of optical fibers are bare optical fibers and comprise glass cladding surfaces in lateral contact with one another.

In certain embodiments, each optical fiber of the plurality of optical fibers comprises a core, a cladding layer, and a hard coating layer having a Young's modulus greater than 100 MPa, and optical fibers of the plurality of optical fibers comprise hard coating layer surfaces in lateral contact with one another.

In certain embodiments, each optical fiber of the plurality of optical fibers comprises an outer diameter in a range of 50 μm to 150 μm, or 100 μm to 150 μm.

In certain embodiments, a coherent fiber optic bundle breakout cable assembly includes a trunk fiber bundle ferrule comprising a single bundle ferrule or a multi-bundle ferrule, and defining at least one trunk fiber ferrule aperture receiving the plurality of optical fibers proximate to the trunk connector end face, and the assembly further includes one or more breakout bundle ferrules, each comprising a single bundle ferrule or a multi-bundle ferrule, wherein each breakout bundle ferrule defines at least one breakout bundle aperture receiving a corresponding group of optical fibers of the plurality of breakout bundles.

In certain embodiments, the plurality of optical fibers of the trunk bundle has an optical fiber count in a range of from 60 to 3,000, and for each breakout bundle, the group of optical fibers has an optical fiber count in a range of from 7 to 1,000.

In certain embodiments, adhesive material is provided to bind optical fibers of the plurality of optical fibers at a furcation section embodying a transition from the trunk fiber bundle to the plurality of breakout bundles.

In certain embodiments, cable jacket material is arranged over the trunk fiber bundle and over each breakout bundle of the plurality of breakout bundles

In certain embodiments, a number of optical fibers in the trunk fiber bundle exceeds an aggregate number of optical fibers in the plurality of breakout bundles, with the number of optical fibers in the trunk bundle including one or more non-functional fibers not arranged to transmit optical signals to any breakout bundles of the plurality of breakout bundles.

In certain embodiments, at least one breakout bundle of the plurality of breakout bundles comprises a pair of subgroups of optical fibers of the plurality of optical fibers, with each subgroup of the pair of subgroups of optical fibers in the breakout bundle being mapped to a corresponding subset of the pair of subsets of optical fibers that is contiguous at the trunk connector end face, wherein each subset of the pair of subsets of optical fibers is not in contact with the other subset of the pair of subsets of optical fibers at the trunk connector end face.

Another aspect of the disclosure relates to a method for fabricating a coherent fiber optic bundle breakout cable assembly, the method comprising multiple steps. One step includes terminating a plurality of optical fibers in a close-packed two-dimensional array configuration within a trunk fiber ferrule aperture of a trunk fiber ferrule arranged at a first end portion of the plurality of optical fibers, wherein each optical fiber of the plurality of optical fibers within the trunk fiber ferrule aperture is arranged in lateral contact with multiple other optical fibers of the plurality of optical fibers. Another step includes holding a second length portion of the plurality of optical fibers with an elastomeric fixture, wherein each optical fiber of the plurality of optical fibers within the trunk fiber ferrule aperture is arranged in lateral contact with multiple other optical fibers of the plurality of optical fibers within the elastomeric fixture. Another step includes dicing the plurality of optical fibers proximate to the elastomeric fixture to provide diced ends of optical fibers of the plurality of optical fibers. Another step includes selectively applying bonding material in interstitial spaces between optical fibers of the plurality of optical fibers proximate to the diced ends according to a bundle-forming pattern. Another step includes curing the bonding material selectively applied to the interstitial spaces. Another step includes separating groups of optical fibers of the plurality of optical fibers into a plurality of breakout bundles, wherein each breakout bundle includes a single bundle or a pair of sub-bundles of bonded optical fibers arranged in a close-packed two-dimensional array configuration and generated by curing the bonding material selectively applied to the interstitial spaces. Yet another step includes, for each breakout bundle of the plurality of breakout bundles, retaining the breakout bundle in a corresponding breakout bundle ferrule aperture of one or more breakout bundle ferrules.

In certain embodiments, the method further comprises, for each breakout bundle of the plurality of breakout bundles, inserting a furcation tube over at least a portion of the breakout bundle.

In certain embodiments, the method further comprises terminating each breakout bundle to a pre-defined leg length.

In certain embodiments, the one or more breakout bundle ferrules comprise portions of one or more breakout bundle connectors.

In certain embodiments, the method further comprises immersing the plurality of optical fibers proximate to the elastomeric fixture in an index-matching liquid, wherein the dicing of the plurality of optical fibers comprises laser dicing of the immersed plurality of optical fibers proximate to the elastomeric fixture.

In certain embodiments, the method further comprises applying a mask over the diced ends of optical fibers of the plurality of optical fibers, wherein the selective applying of bonding material in interstitial spaces between optical fibers of the plurality of optical fibers proximate to the diced ends comprises applying bonding material through openings in the mask to produce the bundle-forming pattern of bonding material.

In certain embodiments, the selective applying of bonding material in interstitial spaces between optical fibers of the plurality of optical fibers proximate to the diced ends comprises piezoelectric jetted (e.g., inkjet-style) printing of bonding material in the interstitial spaces to produce the bundle-forming pattern of bonding material.

In certain embodiments, the bonding material comprises UV-curable adhesive material, and the curing of the bonding material selectively applied to the interstitial spaces comprises impinging UV emissions on the bonding material.

In certain embodiments, the trunk fiber bundle comprises a trunk marker fiber along a perimeter of the trunk fiber bundle, with the trunk marker fiber comprising a marked coating at least at a location proximate to the trunk fiber ferrule, and with the trunk marker fiber being omitted from the plurality of breakout bundles.

In certain embodiments, each breakout bundle of the plurality of breakout bundles comprises a breakout bundle marker optical fiber comprising a marked coating at least at a location proximate to the breakout connector end face, with the breakout bundle marker optical fiber being indicative of breakout bundle polarity.

In certain embodiments, the plurality of optical fibers of the trunk fiber bundle is arranged in a hexagonal close-packed configuration or a rectangular close-packed configuration, and for each breakout bundle of the plurality of breakout bundles, the group of optical fibers is arranged in a hexagonal close-packed configuration or a rectangular close-packed configuration.

In another aspect, any two or more features described in connection with the foregoing aspects and/or other embodiments disclosed herein may be combined for additional advantage.

Additional features and advantages will be set out in the detailed description that follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1A is a cross-sectional view of an exemplary uncoated (bare) optical fiber that includes a glass core and glass cladding surrounding the glass core.

FIG. 1B is a cross-sectional view of an optical fiber with a first hard coating layer (e.g., a hard or high-modulus coating) surrounding glass cladding thereof.

FIG. 1C is a cross-sectional view of an optical fiber with first and second coating layers surrounding glass cladding thereof.

FIG. 2A is a perspective view of an exemplary coherent fiber optic bundle breakout cable assembly according to one embodiment.

FIG. 2B is an elevational view of a single breakout connector end of the coherent fiber optic bundle breakout cable assembly of FIG. 2A.

FIG. 2C is an elevational view of a trunk connector end of the coherent fiber optic bundle breakout cable assembly of FIG. 2A.

FIG. 3A is an elevational view of a trunk fiber connector end of the trunk fiber bundle of FIG. 2C including a plurality of optical fibers in a close-packed hexagonal array, with superimposed identification of thirteen hexagonal groups of optical fibers (with each group containing 19 optical fibers) corresponding to fiber optic breakout bundles to be formed from a portion of the trunk fiber bundle.

FIG. 3B shows the items of FIG. 3A with addition of sequential identifiers to the thirteen hexagonal groups of optical fibers, and with identification of a single marker fiber at a periphery of the trunk fiber bundle for polarity identification.

FIG. 4 is a perspective view of a portion of a fiber optic breakout bundle having nineteen optical fibers in a close-packed hexagonal array, with one peripheral optical fiber being marked (along an exterior or interior thereof) to serve as a marker fiber.

FIG. 5 is a perspective view of an elastomeric fixture having a hexagonal aperture receiving a trunk fiber bundle including a plurality of optical fibers in a close-packed hexagonal array.

FIG. 6 is a side elevational view of the trunk fiber bundle and elastomeric fixture of FIG. 5 in conjunction with a container, with a portion of the trunk fiber bundle being immersed in an index-matching liquid within the container, and with a laser beam being impinged on the immersed trunk fiber bundle portion for dicing optical fibers of the trunk fiber bundle.

FIG. 7 is a perspective view of the trunk fiber bundle and elastomeric fixture of FIG. 6 following completion of optical fiber dicing and following retraction of the trunk fiber bundle to position diced ends of the trunk fiber bundle along one face of the elastomeric fixture.

FIG. 8A is top plan view of a mask including thirteen hexagonal-shaped openings, with the mask being configured to overlay diced ends of optical fibers of the trunk fiber bundle of FIG. 7 to permit selective application of bonding material through the openings into interstitial areas of diced ends of thirteen groups of optical fibers according to a bundle-forming pattern.

FIG. 8B is a top plan view of the mask of FIG. 8A superimposed over the diced ends of optical fibers of the trunk fiber bundle of FIG. 7.

FIG. 8C shows the items of FIG. 8B following application of bonding material through openings in the mask to be received in interstitial areas of the diced ends of thirteen groups of optical fibers.

FIG. 8D is a top plan view of the diced ends of optical fibers of the trunk fiber bundle of FIG. 8C following removal of the mask, with superimposed dashed line hexagons embodying bonding material application areas corresponding to the openings in the mask of FIGS. 8A-8C.

FIG. 8E is an end view of thirteen breakout bundles of optical fibers separated from one another and formed by the selective application of bonding material in interstitial areas of the diced ends of thirteen groups of optical fibers emanating from a trunk fiber bundle.

FIG. 9 is a perspective view of a portion of a coherent fiber optic bundle breakout cable assembly (e.g., corresponding to the assembly shown in FIG. 2), showing the presence of adhesive material binding optical fibers at a furcation section embodying a transition from the trunk fiber bundle to the plurality of breakout bundles.

FIG. 10 is a top plan view of diced ends of optical fibers of a trunk fiber bundle having a hexagonal configuration with selective application of adhesive material to form thirteen hexagonal bonded groups and six bonded trapezoidal subgroups of optical fibers suitable for forming sixteen hexagonal breakout bundles of a coherent fiber optic bundle breakout cable assembly according to one embodiment.

FIG. 11 is a top plan view of diced ends of optical fibers of a trunk fiber bundle having a rectangular configuration suitable for forming twelve rectangular breakout bundles of a coherent fiber optic bundle breakout cable assembly according to one embodiment.

FIG. 12 is a schematic illustration of an optical switching arrangement including multiple graphic processing units and multiple switches coupled with multiple coherent fiber optic bundle breakout cable assemblies as disclosed herein.

FIG. 13 is a schematic illustration of an application specific integrated circuit (ASIC) switching unit with in-package optics, receiving breakout bundle connectors of multiple coherent fiber optic bundle breakout cable assemblies as disclosed herein.

FIG. 14 is a schematic illustration of a graphic processing unit (GPU) assembly with in-package optics, receiving trunk bundle connectors of multiple coherent fiber optic bundle breakout cable assemblies as disclosed herein.

### DETAILED DESCRIPTION

Various embodiments will be further clarified by examples in the description below. In general, the description relates to coherent fiber optic bundle breakout cable assemblies each comprising a trunk fiber bundle having a plurality of optical fibers in a close-packed 2D array at a trunk connector end face, and multiple breakout bundles emanating from the trunk fiber bundle and each including a group of optical fibers in a close-packed 2D array at a breakout connector end face. In the trunk fiber bundle and each breakout bundle, optical fibers are in lateral contact with one another (e.g., along glass cladding surfaces, or along surface of hard precision coating materials). Bonding material is arranged in interstitial spaces of optical fibers near ends of each breakout bundle. For each breakout bundle, optical fibers at a breakout connector end face are mapped to a set, or a pair of subsets, of optical fibers of the trunk fiber bundle that are contiguous at the trunk connector end face. Such mapping provides one-to-one correspondence concerning the arrangement of input and output fibers, without requiring marking of every fiber of a trunk fiber array.

Glass fibers typically have precise cladding-to-core concentricity and precise outer dimensions (i.e., along outer cladding surfaces). However, concerns such as mechanical abrasion, binding, and/or fracturing have limited the practical use and potential reliability of cable assemblies having glass surfaces of optical fibers in direct lateral contact in a packed array. One way to mitigate these concerns is by forming a titanium-doped stress layer portion of (i.e., within) fiber cladding. Another way to mitigate these concerns is by providing a thin, hard, and geometrically precise coating of one or more layers over glass cladding of optical fibers to be arranged in lateral contact with one another. Examples of suitable coating materials include hard polymers, metals, and inorganic materials. Providing a precision hard coating permits exterior surfaces of optical fibers to be arranged in a close-packed array with tight dimensional tolerances, without requiring use of precision mechanical faceplates (that would reduce bandwidth density) or other alignment features, while still providing repeatable fiber alignment at connector ends of a cable assembly. Embodiments here employ optical fibers (whether bare optical fibers or hard coated optical fibers) with outer surfaces in direct lateral contact with other optical fibers in close-packed two-dimensional array configuration within a trunk fiber bundle, and within multiple breakout bundles, of a coherent fiber optic bundle breakout cable assembly. The precise outer dimensions and concentricity of these optical fibers permits the optical fibers themselves to be used as datum surfaces for fiber alignment.

Further details regarding the subject matter of the disclosure are provided hereinafter, after introduction to terminology used in the application.

### Reference Numbers and Terminology

The use herein of ordinals in conjunction with an element is solely for distinguishing what might otherwise be similar or identical labels, such as “first” and “second,” and does not imply a priority, a type, an importance, or other attribute, unless otherwise stated herein.

The term “about” as used herein in conjunction with a numeric value means any value that is within a range of ten percent greater than or ten percent less than the numeric value.

The term “substantially” used herein in conjunction with a geometric property or characteristic (e.g., “substantially flush”) includes slight deviations from the geometric property/characteristic in question due to manufacturing limitations and tolerances.

In this disclosure, when numerical ranges are discussed (e.g., “X to Y” or “between X and Y”, with X and Y being integers), the ranges include the stated end points.

As used herein, the articles “a” and “an” in reference to an element refers to “one or more” of the element unless otherwise explicitly specified. The word “or” as used herein is inclusive unless contextually impossible. As an example, the recitation of A or B means A, or B, or both A and B.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In this disclosure, the term “optical fiber” (or “fiber”) is used in a generic sense and may encompass bare optical fibers, hard-coated optical fibers, soft-coated optical fibers, or buffered optical fibers, as well as optical fibers including different sections corresponding to these fiber types, unless it is clear from the context which of the types is intended. An “optical fiber” refers to a waveguide having a glass portion optionally surrounded by a coating. The glass portion includes a core and a cladding and is referred to herein as a “glass fiber.” “Bare optical fibers” (including “bare glass optical fibers”) or “bare sections” are those with no coating present on the fiber cladding. A bare optical fiber may have an outer diameter in a range of 50 μm to 150 μm, or 50 μm to 150 μm, in certain embodiments. “Coated optical fibers” or “coated sections” include a single or multi-layer coating material surrounding the fiber cladding. “Hard-coated optical fibers” have a thin (e.g., typically less than 10 μm, such as within a thickness range between 0.1 μm and 10 μm) coating over fiber cladding, with such hard coating typically having a Shore D hardness of greater than 60, or greater than 100, and such hard coating may include a suitable metal, inorganic, and/or hard polymer material. A hard-coated optical fiber may have an outer diameter in a range of 50 μm to 160 μm (or 50 μm to 150 μm) in certain embodiments. “Soft-coated optical fibers” have a low hardness polymer coating (e.g., acrylic) typically with a nominal (i.e., stated) diameter no greater than twice the nominal diameter of the bare optical fiber. An outer diameter of a soft-coated optical fiber may be about 200 μm, about 250 μm, or another suitable value. In certain embodiments, an optical fiber having a glass core as disclosed herein may be configured to carry (e.g., conduct) optical signals in a wavelength range of 850 nm to 1550 nm. Optical fibers herein may encompass single-mode and multi-mode varieties.

“Concentricity” (or “concentricity error”) is defined as the distance between the geometric centers of two shapes/profiles, where one of the shapes surrounds the other shape. The shapes/profiles may be defined by different elements, such as the outer surface of a polymer coating and the outer surface of a core as discussed in greater detail below. Thus, the concentricity of a polymer coating relative to a core is the distance between a geometric center of the polymer coating and a geometric center of the core.

### Preferred Embodiments

Reference will now be made in detail to the presently preferred embodiments, examples of which are illustrated in the following drawings. Whenever feasible, the same or corresponding reference numerals will be used throughout the drawings to refer to the same or like parts.

The embodiments set out below represent the information to enable those skilled in the art to practice the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

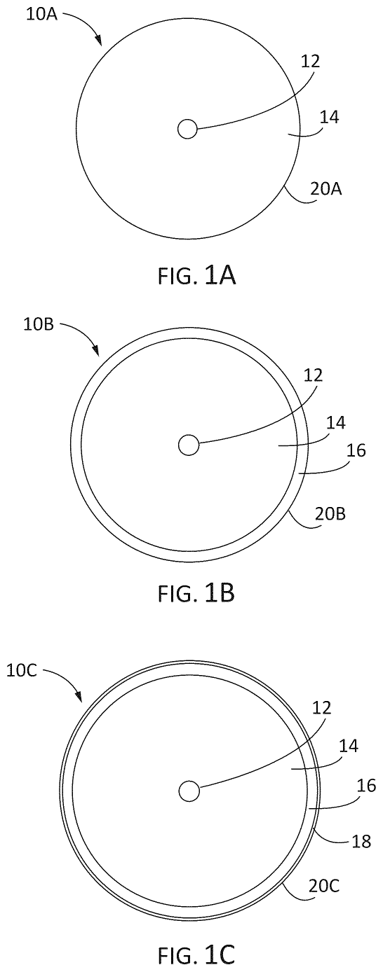

FIGS. 1A-1C are cross-sectional views of exemplary optical fibers that may be used in coherent fiber optic bundle breakout cable assemblies as disclosed herein, with such optical suitable for being arranged in direct lateral contact with one another in two-dimensional arrays of trunk fiber bundles or breakout bundles of such cable assemblies. FIG. 1A is a cross-sectional view of an exemplary uncoated (bare) optical fiber 10A that includes a silica glass core 12 and silica glass cladding 14 surrounding the glass core 12, with the optical fiber 10A having an outer surface 20A defined by the glass cladding 14. The core 12 has a higher refractive index than the cladding 14. The core 12 comprises silica glass, which may be undoped silica glass, undoped silica glass, and/or downdoped silica glass. For a single-mode optical fiber, the radius of the core 12 may be in the range from about from about 3.0 μm to about 6.5 μm, or in the range from about 3.5 μm to about 6.0 μm, or in the range from about 4.0 μm to about 6.0 μm, or in the range from about 4.5 μm to about 5.5 μm. For a multi-mode fiber, the radius of the core may be in the range of about 4 μm to about 100 μm, or any suitable subrange thereof. The cladding 14 is composed of one or more materials with an appropriate refractive index differential to provide desired optical characteristics with the core 12. In embodiments in which core 12 is doped with Ge and/or Cl, the cladding 14 may comprise silica that is substantially free of Ge and/or Cl. In some embodiments, the radius of cladding 14 may be in the range from about 8.0 μm to about 16.0 μm, or in the range from about 9.0 μm to about 15.0 μm, or in the range from about 10.0 μm to about 14.0 μm, or in the range from about 10.5 μm to about 13.5 μm, or in the range from about 11.0 μm to about 13.0 μm. The thickness of the cladding 14 may be in the range from about 3.0 μm to about 10.0 μm, or from about 4.0 μm to about 9.0 μm, or from about 5.0 μm to about 8.0 μm. Optionally, the cladding 14 may include a titanium-doped stress layer portion along an exterior thereof.

FIG. 1B is a cross-sectional view of a hard coated optical fiber 10B including a silica glass core 12, silica glass cladding 14 surrounding the glass core 12, and a first hard coating layer 16 (e.g., a hard or high-modulus coating) applied to an exterior of the cladding 14, with the optical fiber 10B having an outer surface 20B defined by the first hard coating layer 16. FIG. 1C is a cross-sectional view of a hard coated optical fiber 10C including a silica glass core 12, silica glass cladding 14 surrounding the core 12, a first hard coating layer 16 (e.g., a hard or high-modulus coating) applied to an exterior of the cladding 14, and a second coating layer 18 applied over the first hard coating layer 16, with the optical fiber 10C having an outer surface 20C defined by the second coating layer 18. In certain embodiments, the second coating layer 16 may comprise a hard coating layer. In certain embodiments, the second coating layer 18 may comprise a very thin colored or pigmented layer, that may or may not have a high modulus of elasticity, but may be sufficiently thin (e.g., preferably less than 3 μm, less than 2 μm, or less than 1 μm) to have negligible impact on compressibility (and therefore external hardness properties) of the optical fiber 10C.

In certain embodiments, a hard coating layer (16 and/or 18) may comprise a hard polymer coating material having a substantially consistent thickness (and therefore a substantially consistent outer diameter) along a length of optical fiber 40. In some embodiments, the thickness of a polymer coating is in a range of from 20 nm to 20 μm, or in a range of between 0.1 μm and 10 μm. In some embodiments, the thickness of a hard polymer coating is between 0.1 μm and 10 μm, 0.1 μm and 5 μm, or 0.1 μm and 2.5 μm about the circumference of an optical fiber (10A-10C). In some embodiments, the thickness of a hard polymer coating has a standard deviation ranging between 0.1 μm and 0.5 μm, 0.1 μm and 0.3 μm, or 0.1 μm and 0.2 μm. The hard polymer coating 46 is made of various materials including UV-cured acrylates or organic UV-curing acrylate resins filled with SiO₂ or ZrO₂ nanoparticles or non-acrylate polymers such as polyimides. A hard polymer coating may also include a silane additive to promote bonding to glass or inorganic surfaces. In some embodiments, the silane additive includes acryloxy silanes, methacrylate silanes, or Mercapto silanes, such as (3-Mercaptopropyl) trimethoxysilane and (3-acryloxypropyl) trimethoxysilane. In some embodiments, a hard polymer coating has an elastic modulus value greater than 0.3 GPa, greater than 1 GPa, or greater than 2.5 GPa. In one embodiment, a hard polymer coating has an elastic modulus higher than 0.5 GPa or higher than 1 GPa. In another embodiment, a hard polymer coating has an elastic modulus of about 2.5 GPa. In some embodiments, a hard polymer coating has a hardness (Shore D) value greater than 60, greater than 70, greater than 80, greater than 90, or greater than 100. In one embodiment, a hard polymer coating has a hardness (Shore D) value of about 95. In some embodiments, a hard polymer coating has a pencil hardness value greater than 3H, greater than 4H, or greater than 5H on Polymethylmethacrylate (PMMA) film. In some embodiments, a hard polymer coating has a thickness between 0.1 μm and 10 μm, a Shore D hardness greater than 60, and a concentricity relative to a fiber core (12) ranging between 0.1 μm and 0.5 μm.

In certain embodiments, a hard polymer coating (e.g., 16 and/or 18) may be applied onto a glass optical fiber (10A-10C) such that a concentricity of the hard polymer coating relative to the core 12 is limited to a narrow range. In some embodiments, the concentricity of a hard polymer coating (16 and/or 18) relative to the core 12 ranges between 0.1 μm and 0.5 μm, 0.1 μm and 0.3 μm, or 0.1 μm and 0.2 μm. In one embodiment, the concentricity of a polymer coating (16 and/or 18) relative to a core 12 is less than about 0.15 μm. Additional details concerning formation of hard polymer coatings on glass optical fibers are disclosed in U.S. Patent Application Publication No. 2022/0026604 A1 published on Jan. 27, 2022 in the name of Corning Research & Development Corporation, wherein the entire contents of the foregoing publication are hereby incorporated by reference herein.

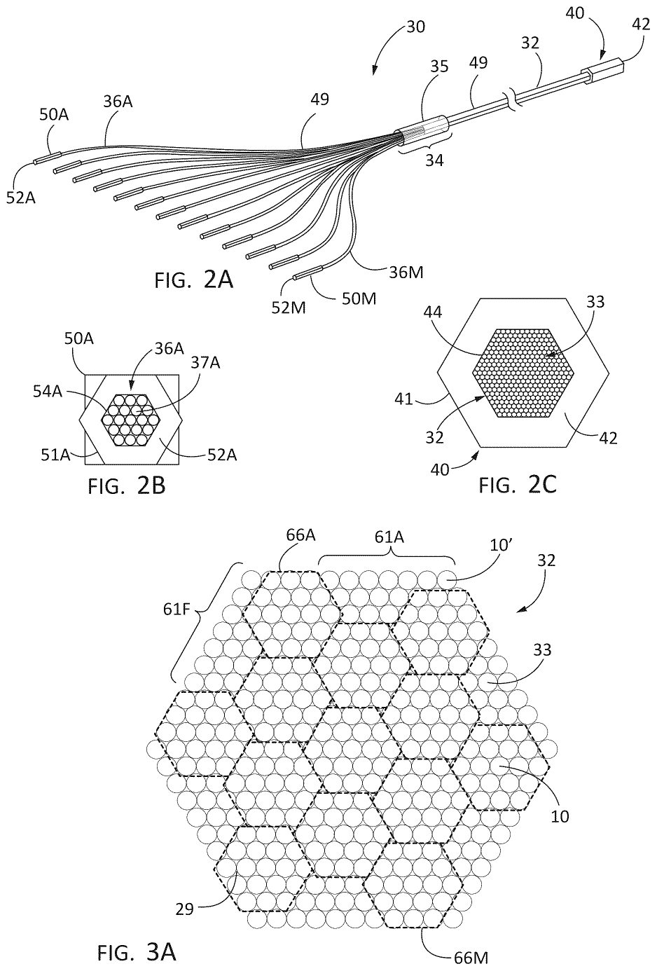

FIG. 2A is a perspective view of an exemplary coherent fiber optic bundle breakout cable assembly 30 according to one embodiment. The cable assembly 30 includes a trunk fiber bundle 32 and multiple breakout bundles 36A-36M emanating from the trunk fiber bundle 32. A furcation section 34 is provided at a transition between the trunk fiber bundle 32 and the breakout bundles 36A-36M, with adhesive material 35 being arranged (e.g., potted) at the furcation section 34 to protect fibers at the transition. Optionally, cable jacket material 49 and/or a furcation tube may be arranged over the trunk fiber bundle 32 and/or over each breakout bundle 36A-36M for environmental protection and wear resistance. Optionally, cable jacket material 49 may be embodied in a furcation tube. Although thirteen breakout bundles 36A-36M of identical lengths are shown, it is to be appreciated that any suitable number of breakout bundles may be provided, and that breakout bundles may have differing lengths if desired. As shown, the trunk fiber bundle 32 includes a trunk fiber connector 40 having a trunk fiber connector end 42, and each breakout bundle 36A-36M includes a breakout bundle connector 50A-50M having a corresponding breakout bundle connector end 52A-52M. In certain embodiments, multiple breakout bundles may be received by a multi-bundle connector configured to receive two or more breakout bundles.

FIG. 2B shows a single breakout connector end 52A of one breakout bundle 36A of the cable assembly 30, with the breakout bundle 36A including a breakout connector 50A having a breakout bundle ferrule 51A having a breakout bundle ferrule aperture 54A receiving optical fibers of the breakout bundle 36A, with optical fiber ends 37A being shown. In certain embodiments, the optical fiber diced ends 37A may be substantially flush with the breakout bundle connector end 52A that is defined by the breakout bundle ferrule 51A. As shown, the optical fiber ends 37A are in lateral contact with one another at the breakout connector end 52A in a close-packed two-dimensional array (encompassing nineteen optical fibers) having a hexagonal shape.

FIG. 2C shows a trunk connector end 42 of trunk fiber bundle 32 of the cable assembly 30, with the trunk fiber bundle 32 including a breakout connector 40 including a trunk fiber ferrule 41 having a trunk fiber ferrule aperture 44 receiving a plurality of optical fibers, with optical fiber ends 33 of the trunk fiber bundle 32 being shown. In certain embodiments, the optical fiber ends 33 may be substantially flush with the trunk connector end 42 that is defined by the trunk fiber ferrule 51A. As shown, the optical fiber ends 33 are in lateral contact with one another at the trunk connector end 42 in a close-packed two-dimensional array (encompassing three hundred, thirty-one optical fibers) having a hexagonal shape.

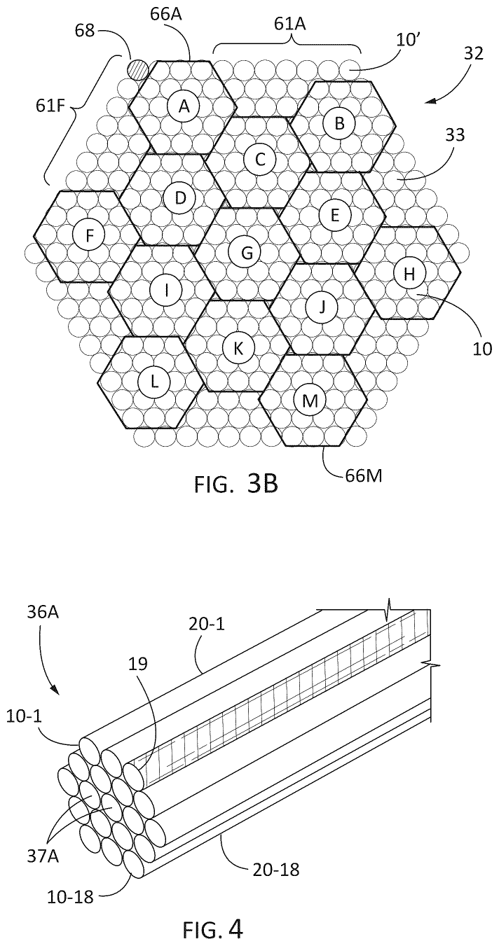

As noted above, the breakout bundles 36A-36M emanate from the trunk fiber bundle 32 of the coherent fiber optic bundle breakout cable assembly 30 of FIG. 2A. FIG. 3A shows optical fiber ends 33 of the trunk fiber bundle 32, with superimposed identification of thirteen hexagonal groups 66A-66M of contiguously arranged optical fibers 10, wherein each group 66A-66M contains nineteen optical fibers 10 representing a subset of the plurality of optical fibers of the trunk fiber bundle 32, and each group 66A-66M corresponds to a different fiber optic breakout bundle of the fiber optic breakout bundles 36A-36M shown in FIG. 2A. Outside the groups 66A-66M of optical fibers 10, the trunk fiber bundle 32 further includes six groups 61A-61F of non-functional fibers 10′ (with fourteen non-functional fibers 10′ per group 61A-61F) that are not included in the breakout bundles 36A-36M of FIG. 2A, and therefore are not capable of transmitting optical signals between the trunk connector end 42 and the breakout connector ends 52A-52M. The six groups 61A-61F of non-functional fibers 10′ are distributed around six sides of the hexagonal array of optical fibers of the trunk fiber bundle 32. With a known orientation and placement of the hexagonal groups 66A-66M of optical fibers 10 at the trunk connector end 42 corresponding to the fiber optic breakout bundles 36A-36M (shown in FIG. 2A), optical fibers of the breakout bundles 36A-36M at the breakout connector end faces 52A-52M (in FIG. 2A) are mapped to optical fibers of corresponding groups 66A-66M of optical fiber ends 33 at the trunk connector end face 42 (in FIG. 2A). Thus, a one-to-one correspondence may be established between individual optical fibers 10 of the breakout bundles 36A-36M and optical fibers of the trunk fiber bundle 32 without need for marking of each individual optical fiber 10.

In certain embodiments, one or more optical fibers (preferably at least one peripheral optical fiber) of the plurality of optical fibers of the trunk fiber bundle may be marked (e.g., with an exteriorly arranged ink, pigment, coating, surface treatment, or the like, or interiorly arranged colored or contrasting doping) to provide polarity identification. FIG. 3B shows the optical fiber ends 33 of the trunk fiber bundle 32 and superimposed hexagonal groups 66A-66M previously shown in FIG. 3A, with a single marker fiber 68 at a perimeter of the hexagonal array being part of the one of the groups 61A-61F of non-functional fibers 10′. FIG. 3B also includes sequential identifiers A to M for the superimposed hexagonal groups 66A-66M of optical fibers 10 that correspond to breakout bundles. As shown, the identifiers for the hexagonal groups 66A-66M are sequential incremented by vertical position, with the uppermost group having identifier “A” corresponding to group 66A, and the lowermost group having identifier “M” corresponding to group 66M.

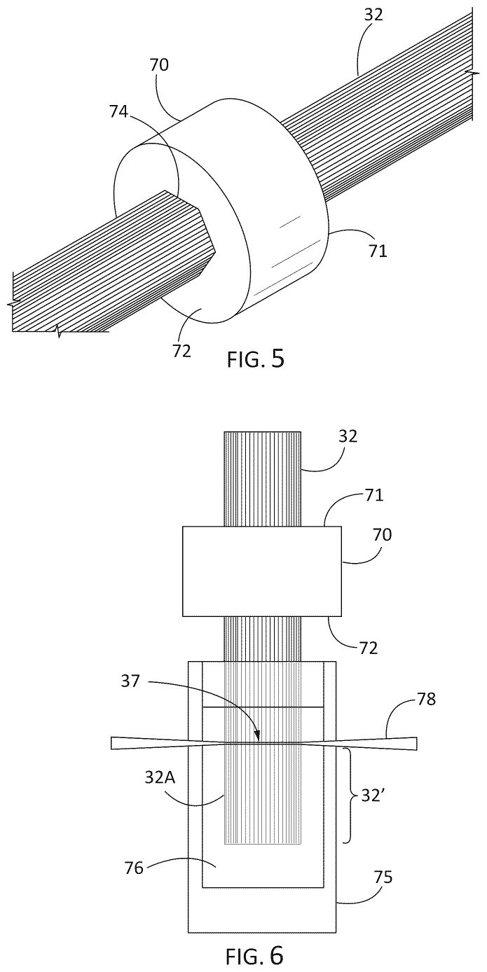

In certain embodiments, fiber optic breakout bundles may include one or more marker fibers to provide polarity identification. The marker fiber may be functional. FIG. 4 is a perspective view of a portion of a fiber optic breakout bundle 36A having a total nineteen optical fibers in a close-packed hexagonal array, including eighteen unmarked optical fibers 10-1 to 10-18, and one peripheral marker fiber 19 embodying an optical fiber that is marked (e.g., along an exterior or interior thereof) to serve as a marker fiber for polarity identification, to provide a total of nineteen functional optical fibers 10-1 to 10-18, 19. As shown, the unmarked optical fibers 10-1 to 10-18 include external surfaces 20-1 to 20-18 that are in lateral contact with one another (and with the marker fiber 19) at optical fiber ends 37A of the breakout bundle 36A. As will be described hereinafter in conjunction with a method for fabricating a coherent fiber optic bundle breakout cable assembly, interstitial spaces between the optical fibers 10-1 to 10-18 and the marker fiber 19 proximate to the optical fiber ends 37A may include bonding material to preserve the placement of optical fibers of the breakout bundle 36A.

As noted hereinabove, an exemplary method for fabricating a coherent fiber optic bundle breakout cable assembly includes multiple steps. One step includes terminating a plurality of optical fibers (e.g., 10, 10′ in FIGS. 3A, 3B) in a close-packed two-dimensional array configuration within a trunk fiber ferrule aperture (e.g., 44 in FIG. 2C) of a trunk fiber ferrule (e.g., 41 in FIG. 2C) arranged at a first end portion of the plurality of optical fibers, wherein each optical fiber (e.g., 10, 10′ in FIGS. 3A, 3B) of the plurality of optical fibers within the trunk fiber ferrule aperture (44 in FIG. 2C) is arranged in lateral contact with multiple other optical fibers of the plurality of optical fibers. Another step includes holding a second length portion of the plurality of optical fibers with an elastomeric fixture (e.g., fixture 70 shown in FIG. 5), wherein each optical fiber of the plurality of optical fibers is arranged in lateral contact with multiple other optical fibers of the plurality of optical fibers within the elastomeric fixture. Another step includes dicing the plurality of optical fibers proximate to the elastomeric fixture to provide diced ends of optical fibers of the plurality of optical fibers. Another step includes selectively applying bonding material in interstitial spaces between optical fibers of the plurality of optical fibers proximate to the diced ends according to a bundle-forming pattern. Another step includes curing the bonding material selectively applied to the interstitial spaces. Another step includes separating groups of optical fibers of the plurality of optical fibers into a plurality of breakout bundles, wherein each breakout bundle includes a single bundle or a pair of sub-bundles of bonded optical fibers arranged in a close-packed two-dimensional array configuration and generated by curing the bonding material selectively applied to the interstitial spaces. Yet another step includes, for each breakout bundle of the plurality of breakout bundles, retaining the breakout bundle in a corresponding breakout bundle ferrule aperture of one or more breakout bundle ferrules.

FIG. 5 is a perspective view of an elastomeric fixture 70 having opposed first and second faces 71, 72, the elastomeric fixture 70 defining a hexagonal aperture 74 extending between the first and second faces 71, 72. FIG. 5 additionally shows a length portion of a trunk fiber bundle 32 (intermediate between bundle ends, and including a plurality of optical fibers in a close-packed hexagonal array) extending through the hexagonal aperture 74. The elastomeric fixture 70 is intended to gently compress optical fibers of the trunk fiber bundle 32 to retain direct lateral contact therebetween, while being slidable relative to the trunk fiber bundle 32. With the elastomeric fixture 70 slidably retaining optical fibers of the trunk fiber bundle 32 in a close-packed configuration, optical fibers of the trunk fiber bundle 32 may be diced.

In certain embodiments, dicing may be performed by laser dicing (also known as laser cleaving), such as ultrafast laser nano-perforation or non-dicing using a Bessel beam, preferably while a portion of the trunk fiber bundle 32 is immersed in an index matching liquid (i.e., a liquid index matched to the optical fibers of the trunk fiber bundle 32) such as water. A laser beam is only slightly refracted through the trunk fiber bundle 32 when it is immersed in an index matching liquid. Immersion in index matching liquid is beneficial to avoid laser beam refraction that would result in a dry condition, whereby interstitial air interfaces in the trunk fiber bundle would strongly refract the laser beam and thereby laser penetrating depth to less than two layers of fibers. If Bessel beam dicing is used with the trunk fiber bundle 32 immersed in an index matching liquid, the collimation length of the Bessel beam may be designed to at least match the total thickness of the trunk fiber bundle 32. In certain embodiments, collimation length of a Bessel beam may exceed 3 mm, which is sufficient to cover a wide range of sizes of trunk fiber bundle sizes. Laser processing results in a flat end face of optical fibers of the trunk fiber bundle. In contrast, mechanical cutting or lapping of a loosely held trunk fiber bundle would be anticipated to result in fiber length variations of over 1 mm, which may render difficult any subsequent selective application of bonding material in interstitial spaces between diced optical fibers of the trunk fiber bundle.

FIG. 6 is a side elevational view of the trunk fiber bundle 32 and elastomeric fixture 70 of FIG. 5 in conjunction with an open container 75, with a portion 32A of the trunk fiber bundle 32 being immersed in an index-matching liquid 76 within the container 75, and with a laser beam 78 being impinged on the portion of the immersed trunk fiber bundle 32A for dicing optical fibers thereof. As noted above, the laser dicing may include Bessel beam dicing, and the index-matching liquid 76 may include water. Upon completion of laser dicing, an end portion 32′ is separated from the remainder of the trunk fiber bundle 32, and the trunk fiber bundle 32 includes diced ends 37 of optical fibers of the trunk fiber bundle 32. The trunk fiber bundle 32 may be removed from the container 75 and index matching liquid 76 after laser dicing is complete.

Following dicing of the trunk fiber bundle 32 to form diced ends 37, bonding material is selectively applied in interstitial areas between optical fibers proximate to the diced ends according to a bundle forming pattern configured to produce multiple breakout bundles (optionally including sub-bundles that may be subsequently paired to form breakout bundles). As shown in FIG. 7, in certain embodiments, the elastomeric fixture 70 may be positioned (e.g., by sliding) to cause diced ends 37 of the trunk fiber bundle 32 (of the trunk fiber bundle 32 still retained within the fixture aperture 74) to be proximate to, or substantially flush with, one face (e.g., face 72) of the elastomeric fixture 70, prior to application of bonding material. One example of a suitable bonding material that may be applied to interstitial spaces between diced ends 37 of a trunk fiber bundle 32 is an ultraviolet (UV) curable adhesive material. Other bonding materials may be used, such as thermally curable adhesives, chemically curable adhesives, epoxies, or the like. After deposition of bonding material, such material may be cured by a method appropriate to the bonding material (e.g., via UV emissions, heat, chemical addition, etc.). In certain embodiments, bonding material may be selectively applied to interstitial spaces between diced ends 37 of a trunk fiber bundle 32 via deposition by piezoelectric jetted (e.g., inkjet-style) printing, followed by curing. In certain embodiments, a mask defining multiple openings (e.g., windows corresponding to a bundle-forming pattern) may be applied over diced ends of a trunk fiber bundle 32, and bonding material may be selectively applied to interstitial spaces between diced ends 37 of the trunk fiber bundle 32 by application of bonding material openings of the mask, followed by curing of the bonding material. If the bonding material comprises UV-curable adhesive, a suitable mask may be hydrophobic and UV-impermeable, and the mask may remain present during a UV curing step. If UV-curable bonding should wick (or otherwise leak) to areas between (and not overlapped by) windows in the mask, presence of a UV-impermeable mask may beneficially prevent curing of the bonding material in areas of the bundle not overlapped by windows in the mask.

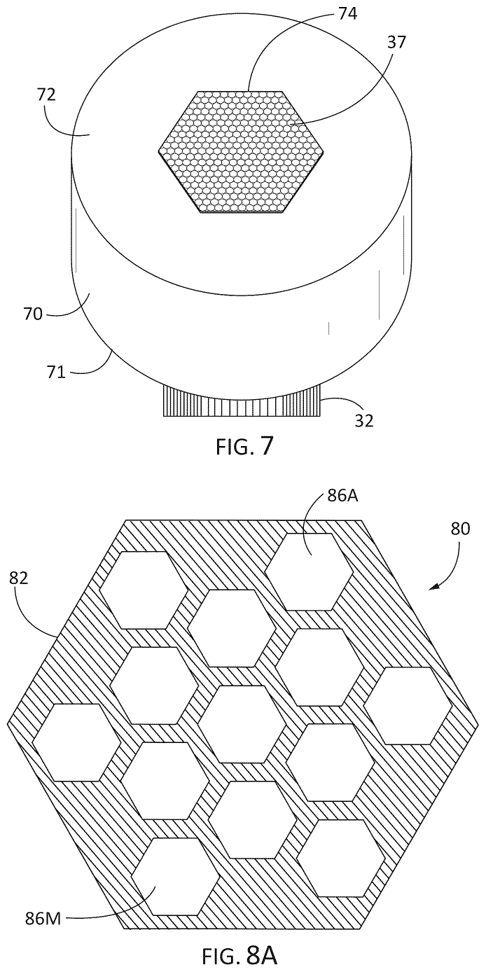

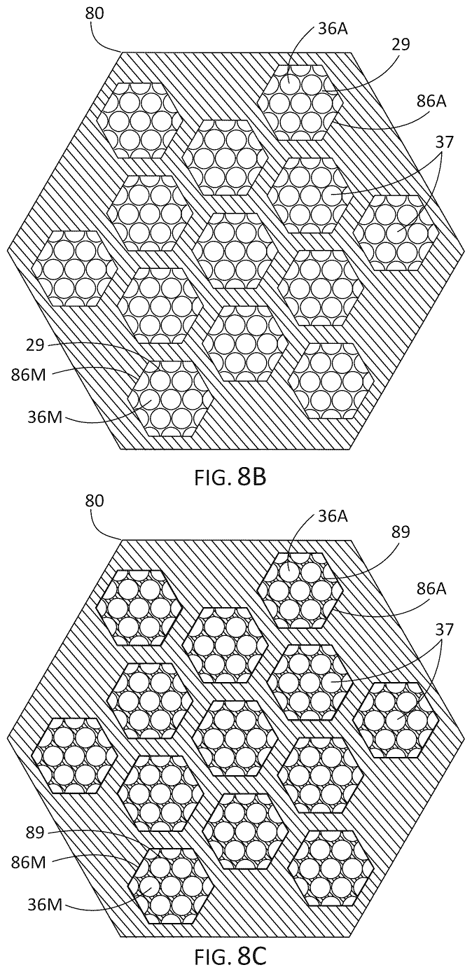

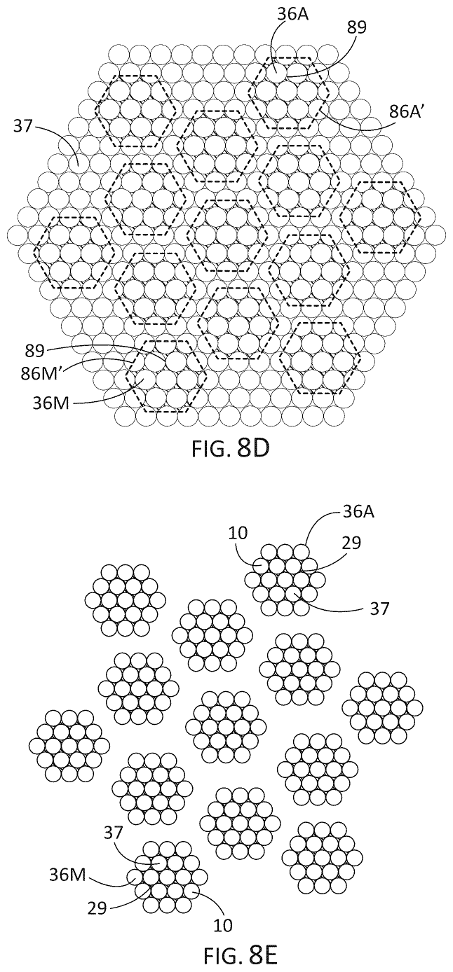

FIG. 8A is top plan view of a mask 80 including a body 82 defining thirteen hexagonal-shaped openings 86A-86M, with the mask 80 being configured to overlay diced ends 37 of optical fibers of the trunk fiber bundle 32 of FIGS. 6 and 7. In certain embodiments, the mask 80 comprises a hydrophobic and UV-impermeable material. The openings 86A-86M in the mask 80 may be defined by laser cutting, waterjet cutting, blade cutting, or the like. In certain embodiments, one surface of the mask 80 configured to contact diced ends of optical fibers may comprise non-permanent adhesive to promote sealing.

FIG. 8B is a top plan view of the mask 80 of FIG. 8A superimposed over diced ends 37 of optical fibers of the trunk fiber bundle of FIG. 7. Each opening 86A, 86M in the mask 80 exposes interstitial spaces 29 between diced ends 37 of nineteen contiguous optical fibers (exposing diced ends 37 of seven optical fibers in their entirety, and diced ends 37 of portions of twelve additional optical fibers) arranged in a hexagonal configuration. In certain embodiments, the mask 80 may be removably adhered to diced ends 37 of underlying optical fibers. FIG. 8C shows the items of FIG. 8B following application of bonding material 89 through the openings 86A-86M in the mask 80 to be received in interstitial spaces (29 in FIG. 8B) between diced ends 37 of optical fibers according to a bundle-forming pattern configured to form thirteen groups 36A-36M of optical fibers, with each group 36A-36M having nineteen bonded optical fibers. After application of bonding material 89, the bonding material 89 is cured (e.g., by impinging UV emissions through the openings 86A-86M in the mask 80, or by other curing means as disclosed herein). FIG. 8D shows the diced ends 37 of optical fibers of the trunk fiber bundle of FIG. 8C following removal of the mask, with superimposed dashed line hexagons embodying bonding material application areas 86A′-86M′ corresponding to the openings 86A-86M in the mask 80 of FIGS. 8A-8C. As shown, bonding material 89 is provided within the bonding material application areas 86A′-86M′ and is subsequently cured to form thirteen groups of bonded optical fibers 36A-36M that will correspond to breakout bundles of a cable assembly (e.g., coherent fiber optic bundle breakout cable assembly 20 in FIG. 2A).

FIG. 8E is an end view of the thirteen breakout bundles 36A-36M of optical fibers 10 separated from one another and formed by the selective application of bonding material 89 in interstitial areas of the diced ends 37 of the optical fibers 10. In FIG. 8E, unbonded fibers (corresponding to the six groups 61A-61F of non-functional fibers 10′ shown in FIG. 3A) are omitted, since any unbonded fibers are not included in the breakout bundles 36A-36M, and may be trimmed to a furcation section (e.g., furcation section 34 shown in FIG. 2A). To aid in separating the breakout bundles 36A-36M from one another, each breakout bundle 36A-36M may be passed through a corresponding tight-clearance hexagonal opening in a separation fixture (which may be substantially identical in appearance to the mask 80 shown in FIG. 8A). Cable jacket material (49 in FIG. 2) may be placed over each breakout bundle 36A-36M and over the trunk fiber cable (32 in FIG. 2). If desired, the cable jacket material 49 of each breakout bundle 36A-36M cable jacket may comprise different colors, number, and/or other markings specific to each breakout bundle 36A-36M. In certain embodiments, each breakout bundle 36A-36M may include a marker fiber (e.g., 19 as shown in FIG. 4) for polarity identification. In certain embodiments, after the breakout bundles 36A-36B are separated from one another, each breakout bundle 36A-36B may be retained in an aperture of a single-aperture breakout bundle ferrule or a multi-aperture breakout bundle ferrule.

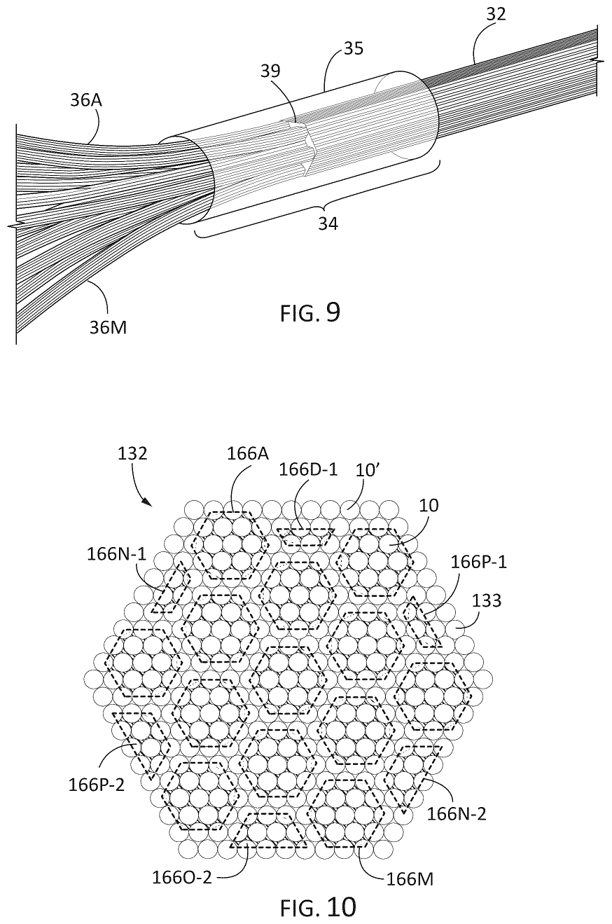

In certain embodiments, after breakout bundles are separated from one another (e.g., and after non-functional fibers are trimmed to a furcation section), adhesive material may be applied to a furcation section representing a transition between a trunk fiber bundle and the multiple breakout bundles, to provide environmental and mechanical protection. FIG. 9 is a perspective view of a portion of a coherent fiber optic bundle breakout cable assembly (e.g., corresponding to the assembly 30 shown in FIG. 2), showing the presence of adhesive material 35 binding optical fibers at a furcation section 34 including a transition point 39 between a trunk fiber bundle 32 and the plurality of breakout bundles 36A-36B each including bonding material (29 in FIG. 8E) in interstitial areas along diced fiber ends thereof.

In order to improve fiber utilization when forming breakout bundles from a trunk fiber bundle, in certain embodiments, selected fibers of a trunk fiber bundle may be arranged into sub-groups of optical fibers having adhered diced ends, wherein pairs of subgroups may be combined (without twist) to form additional trunk fiber bundles. One example of such an embodiment will be described in connection with FIG. 10.

FIG. 10 is a top plan view of diced ends 133 of optical fibers (including functional fibers 10 and non-functional fibers 10′) of a trunk fiber bundle 132 arranged in a close-packed hexagonal array, following selective application of adhesive material in interstitial areas between functional optical fibers 10 to form thirteen hexagonal groups 166A-166M of bonded optical fibers and six trapezoidal subgroups 166N-1, 166N-2, 166O-1, 166O-2, 166P-1, 166P-2 of bonded optical fibers, suitable for forming sixteen hexagonal breakout bundles of a coherent fiber optic bundle breakout cable assembly according to one embodiment. The six trapezoidal subgroups includes three pairs of trapezoidal subgroups 166N-1, 166N-2, 166O-1, 166O-2, 166P-1, 166P-2 of bonded optical fibers, wherein one pair of subgroups 166N-1, 166N-2 may be combined to form one hexagonal group, another pair of subgroups 166O-1, 166O-2 may be combined to form another hexagonal group, and another pair of subgroups 166N01, 166N-2 may be combined to form yet another hexagonal group. This arrangement reduces the number of non-functional fibers 10′ omitted from a coherent fiber optic bundle breakout cable assembly, and therefore improves fiber utilization and bandwidth capability. In the embodiment shown in FIG. 10, sixteen hexagonal groups each including nineteen functional optical fibers may be functional fibers, permitting three hundred four (304) optical fibers to be utilized of a total of three hundred thirty-one (331) optical fibers of the trunk fiber bundle 132 (for a utilization rate of 91.8%), such that only twenty-seven of the three hundred four total optical fibers (i.e., are non-functional fibers 10′ (for a non-utilization rate of 8.2%). In certain embodiments, a coherent fiber optic bundle breakout cable assembly has at least 60, at least 100, at least 200, at least 300, at least 400, at least 600, at least 800, at least 1200, at least 1600, or at least 2000 total fibers, with a functional fiber utilization rate of at least 80%, at least 85%, at least 90%, or at least 92%.

After formation of breakout bundles, breakout bundle ferrules (e.g., 51A in FIG. 2B) may be affixed over bundled optical fibers to form breakout fiber connectors (e.g., 50A-50M in FIG. 2A). A trunk fiber ferrule (e.g., 41 in FIG. 2C) may be arranged over an opposing end of a trunk fiber bundle (e.g., 32 in FIGS. 2A, 2C) prior to utilization of an elastomeric fixture (70 in FIGS. 5-7) employed during optical fiber dicing and breakout bundle formation.

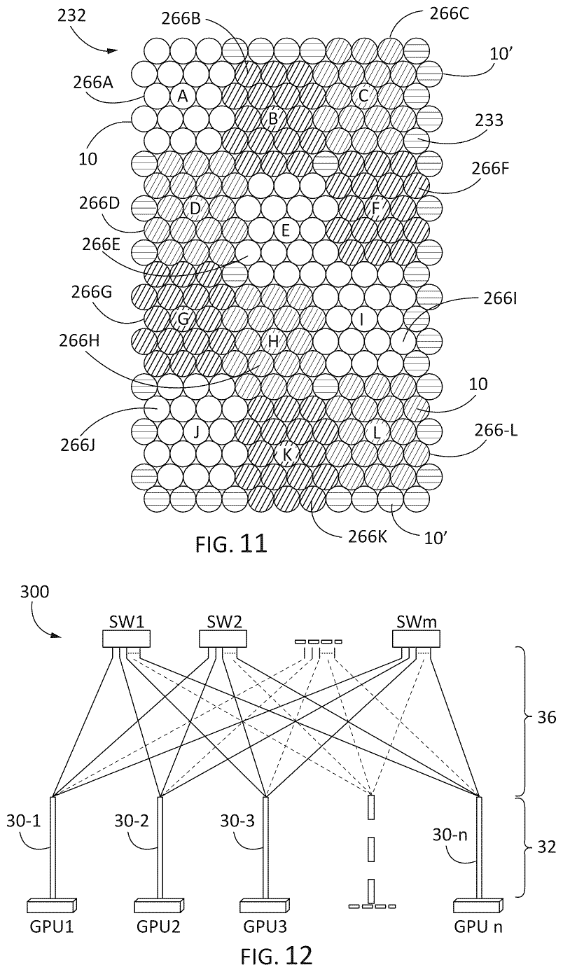

Although various figures of the present application depict a trunk fiber bundle and breakout bundles each having optical fibers arranged in a close-packed two-dimensional array having a hexagonal shape, the disclosure is not limited to use of hexagonal cross-sectional shapes for trunk fiber bundles and breakout bundles. Any suitable cross-sectional shapes may be employed for producing trunk fiber bundles and/or breakout bundles, including rectangular, triangular, trapezoidal, and other shapes, wherein it is noted that a trunk fiber bundle may have a different geometric shape than corresponding breakout bundles. Additionally, differing breakout bundles emanating from the same trunk fiber bundle may include different numbers of optical fibers in certain embodiments. of One example of a trunk fiber bundle being used to form multiple generally rectangular breakout bundles is shown in FIG. 11.

FIG. 11 is a top plan view of diced ends of optical fibers of a trunk fiber bundle 232 having a rectangular configuration suitable for forming twelve rectangular breakout bundles 266A-266L of a coherent fiber optic bundle breakout cable assembly according to one embodiment. Each breakout bundle 266A-266L includes seventeen (17) functional fibers 10, with the trunk fiber bundle 232 including various non-functional fibers 10′ (totaling thirty-four in number) along selected areas of a perimeter thereof, providing a functional fiber utilization rate of 85.7%.

Coherent fiber optic bundle breakout cable assemblies as disclosed herein may be applied to various end uses, including but not limited to optical switching for GPU clusters for generative AI applications, parallel computing, and the like.

FIG. 12 is a schematic illustration of an optical switching arrangement 300 including multiple graphic processing units GPU1-GPUn and multiple switches SW1-SWm being interconnected with multiple coherent fiber optic bundle breakout cable assemblies 30-1 to 30-n as disclosed herein. A total of n GPUs (i.e., GPU1-GPUn) are connected by a total of m switches SW1-SWm in a Clos network to form a GPU scale-up system in a similar design as the Nvidia GB200 NVL system (Nvidia Corporation, Santa Clara, California). The GPUs (GPU1-GPUn) and switches (SW1-SWm) can be located in the same rack or different racks. The coherent fiber optic bundle breakout cable assemblies 30-1 to 30-n allow any of the GPUs (GPU1-GPUn) to connect to multiple switches (SW1-SWm). In a multi-rack system, the furcation point (e.g., 39 in FIG. 9) of a trunk fiber bundle (e.g., 32 in FIG. 2) of each coherent fiber optic bundle breakout cable assembly 30-1 to 30-n can land on a switch rack containing the switches (SW1-SWm), and relatively short breakout bundle legs (e.g., 36A-36M) are needed to reach the switches (SW1-SWm). The lengths of the breakout bundle legs can be staggered according to the designed positions of the switches (SW1-SWm). A coherent fiber optic bundle breakout cable assembly may replace a large number of smaller cables as compared to use of point-to-point connections, thereby greatly reducing cable congestion. More importantly, use of the coherent fiber optic bundle breakout cable assemblies 30-1 to 30-n offers much higher bandwidth density than point-to-point connections, with such bandwidth density being critical crucial for in-package integration of optics with GPU chips.

In certain embodiments, a coherent fiber optic bundle breakout cable assembly may be arranged within a switch box, wherein short internal breakout bundles may be used to increase bandwidth density at a trunk bundle end for in-package optics on a switch chip, with internal breakout bundles being couplable to breakout inputs at connectors located along a switch box front panel.

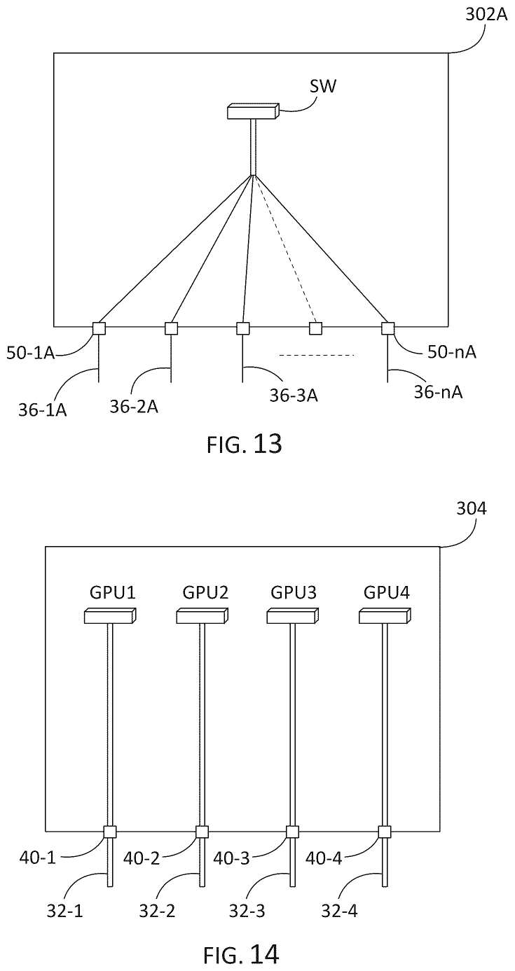

An exemplary switch box 302A including one switch unit SW is shown in FIG. 13. In certain embodiments, the switch box 302A includes connector ports 50-1A to 50-nA configured to receive connector ends of breakout bundles 36-1A to 36-nA (each corresponding to a different coherent fiber optic bundle breakout cable assembly) from multiple different GPUs (e.g., GPU1-GPUn in FIG. 12).

FIG. 14 is a schematic illustration of a graphic processing unit (GPU) assembly including multiple GPUs (GPU1 to GPU4) with in-package optics, receiving trunk bundle connectors 40-1 to 40-4 of multiple coherent fiber optic bundle breakout cable assemblies 32-1 to 32-4 as disclosed herein.

In certain embodiments, a trunk fiber bundle of a first coherent fiber optic bundle breakout cable assembly connects to a transmitter array of in-package optics of a GPU or GPU assembly, and a trunk fiber bundle of a second first coherent fiber optic bundle breakout cable connects to a receiver array of in-package optics of the GPU or GPU assembly. In another embodiment, part of a trunk bundle of a coherent fiber optic bundle breakout cable connects to a transmitter array for a GPU or GPU assembly, another part of the trunk bundle of the same first coherent fiber optic bundle breakout cable connects to a receiver array of the same GPU or GPU assembly.

Each linear link shown in FIGS. 12-14 implies a logic link that may include multiple trunks or bundles, depending on bandwidth requirements. For example, if sixteen optical fibers of one breakout bundle, each carrying 25 Gb/s, are used to transmit a total breakout bandwidth of 400 Gb/s, a trunk fiber bundle incorporating the sixteen breakout bundles may support 6.4 Tb/s. If a single GPU has an I/O bandwidth of 12.8 Tb/s, then in-package optics may require two trunk bundles for transmitters, and two bundles for receivers. The total number of switches in such an instance may be 32, matching the breakouts of two cable assemblies. The I/O bandwidth for one or more GPUS can scale by increasing the number of trunk bundles and/or reducing the fiber diameter. A transmitter array pattern and receiver array pattern can be designed accordingly based on the specific coherent fiber optic bundle breakout cable assembly.

It will be apparent to those skilled in the art that various modifications and variations can be made without departing from the spirit or scope of the invention.

It will also be apparent to those skilled in the art that unless otherwise expressly stated, it is in no way intended that any method in this disclosure be construed as requiring that its steps be performed in a specific order. Accordingly, where a method claim below does not actually recite an order to be followed by its steps or it is not otherwise specifically stated in the claims or descriptions that the steps are to be limited to a specific order, it is no way intended that any particular order be inferred.

What is claimed is:

1. A coherent fiber optic bundle breakout cable assembly comprising:
a trunk fiber bundle comprising a plurality of optical fibers in a close-packed two-dimensional array configuration at a trunk connector end face, wherein each optical fiber of the plurality of optical fibers is arranged in lateral contact with multiple other optical fibers of the plurality of optical fibers at the trunk connector end face; and
a plurality of breakout bundles emanating from the trunk fiber bundle, wherein each breakout bundle of the plurality of breakout bundles comprises a group of optical fibers in a close-packed two-dimensional array configuration at a breakout connector end face, and within each breakout bundle, each optical fiber of the group of optical fibers is arranged in lateral contact with multiple other optical fibers of the group of optical fibers at a breakout connector end face;
wherein for each breakout bundle of the plurality of breakout bundles, each optical fiber of the group of optical fibers comprises an end along the breakout connector end face, with bonding material arranged in interstitial spaces between at least some optical fibers of the group of optical fibers proximate to the breakout connector end face; and
wherein for each breakout bundle of the plurality of breakout bundles, the optical fibers at the breakout connector end face are mapped to a subset, or pair of subsets, of optical fibers of the trunk fiber bundle that are contiguous at the trunk connector end face.

2. The coherent fiber optic bundle breakout cable assembly of claim 1, wherein:
the trunk fiber bundle comprises a trunk marker fiber along a perimeter of the trunk fiber bundle, with the trunk marker fiber comprising a marked coating at least at a location proximate to the trunk connector end face, and with the trunk marker fiber being omitted from the plurality of breakout bundles; and
each breakout bundle of the plurality of breakout bundles comprises a breakout bundle marker optical fiber comprising a marked coating at least at a location proximate to the breakout connector end face, with the breakout bundle marker optical fiber being indicative of breakout bundle polarity.

3. The coherent fiber optic bundle breakout cable assembly of claim 1, wherein for each breakout bundle of the plurality of breakout bundles, the group of optical fibers is arranged in a hexagonal close-packed configuration or a rectangular close-packed configuration.

4. The coherent fiber optic bundle breakout cable assembly of claim 1, wherein the plurality of optical fibers of the trunk fiber bundle is arranged in a hexagonal close-packed configuration or a rectangular close-packed configuration.

5. The coherent fiber optic bundle breakout cable assembly of claim 1, wherein optical fibers of the plurality of optical fibers are bare optical fibers and comprise glass cladding surfaces in lateral contact with one another.

6. The coherent fiber optic bundle breakout cable assembly of claim 1, wherein:
each optical fiber of the plurality of optical fibers comprises a core, a cladding layer, and a hard coating layer having a Young's modulus greater than 100 MPa; and
optical fibers of the plurality of optical fibers comprise hard coating layer surfaces in lateral contact with one another.

7. The coherent fiber optic bundle breakout cable assembly of claim 1, wherein each optical fiber of the plurality of optical fibers comprises an outer diameter in a range of 50 μm to 150 μm.

8. The coherent fiber optic bundle breakout cable assembly of claim 1, further comprising:
a trunk fiber bundle ferrule comprising a single bundle ferrule or a multi-bundle ferrule, and defining at least one trunk fiber ferrule aperture receiving the plurality of optical fibers proximate to the trunk connector end face; and
one or more breakout bundle ferrules, each comprising a single bundle ferrule or a multi-bundle ferrule, wherein each breakout bundle ferrule defines at least one breakout bundle aperture receiving a corresponding group of optical fibers of the plurality of breakout bundles.

9. The coherent fiber optic bundle breakout cable assembly of claim 1, wherein the plurality of optical fibers of the trunk bundle has an optical fiber count in a range of from 60 to 3,000, and for each breakout bundle, the group of optical fibers has an optical fiber count in a range of from 7 to 1,000.

10. The coherent fiber optic bundle breakout cable assembly of claim 1, further comprising adhesive material binding optical fibers of the plurality of optical fibers at a furcation section embodying a transition from the trunk fiber bundle to the plurality of breakout bundles.

11. The coherent fiber optic bundle breakout cable assembly of claim 1, further comprising cable jacket material arranged over the trunk fiber bundle and over each breakout bundle of the plurality of breakout bundles.

12. The coherent fiber optic bundle breakout cable assembly of claim 1, wherein a number of optical fibers in the trunk fiber bundle exceeds an aggregate number of optical fibers in the plurality of breakout bundles, with the number of optical fibers in the trunk bundle including one or more non-functional fibers not arranged to transmit optical signals to any breakout bundles of the plurality of breakout bundles.

13. The coherent fiber optic bundle breakout cable assembly of claim 1, wherein at least one breakout bundle of the plurality of breakout bundles comprises a pair of subgroups of optical fibers of the plurality of optical fibers, with each subgroup of the pair of subgroups of optical fibers in the breakout bundle being mapped to a corresponding subset of the pair of subsets of optical fibers that is contiguous at the trunk connector end face, wherein each subset of the pair of subsets of optical fibers is not in contact with the other subset of the pair of subsets of optical fibers at the trunk connector end face.

14. A graphic processing unit (GPU) system comprising:
a plurality of GPUs;
a plurality of switches; and
at least one coherent fiber optic bundle breakout cable assembly according to claim 1 connected between the plurality of GPUs and the plurality of switches.

15. A method for fabricating a coherent fiber optic bundle breakout cable assembly, the method comprising:
terminating a plurality of optical fibers in a close-packed two-dimensional array configuration within a trunk fiber ferrule aperture of a trunk fiber ferrule arranged at a first end portion of the plurality of optical fibers, wherein each optical fiber of the plurality of optical fibers within the trunk fiber ferrule aperture is arranged in lateral contact with multiple other optical fibers of the plurality of optical fibers;
holding a second length portion of the plurality of optical fibers with an elastomeric fixture, wherein each optical fiber of the plurality of optical fibers is arranged in lateral contact with multiple other optical fibers of the plurality of optical fibers within the elastomeric fixture;
dicing the plurality of optical fibers proximate to the elastomeric fixture to provide diced ends of optical fibers of the plurality of optical fibers;
selectively applying bonding material in interstitial spaces between optical fibers of the plurality of optical fibers proximate to the diced ends according to a bundle-forming pattern;
curing the bonding material selectively applied to the interstitial spaces;
separating groups of optical fibers of the plurality of optical fibers into a plurality of breakout bundles, wherein each breakout bundle includes a single bundle or a pair of sub-bundles of bonded optical fibers arranged in a close-packed two-dimensional array configuration and generated by curing the bonding material selectively applied to the interstitial spaces; and
for each breakout bundle of the plurality of breakout bundles, retaining the breakout bundle in a corresponding breakout bundle ferrule aperture of one or more breakout bundle ferrules.

16. The method of claim 15, further comprising, for each breakout bundle of the plurality of breakout bundles, inserting cable jacket material and/or furcation tube over at least a portion of the breakout bundle.

17. The method of claim 15, further comprising terminating each breakout bundle to a pre-defined leg length.

18. The method of claim 15, wherein the one or more breakout bundle ferrules comprise portions of one or more breakout bundle connectors.

19. The method of claim 15, further comprising immersing the plurality of optical fibers proximate to the elastomeric fixture in an index-matching liquid, wherein the dicing of the plurality of optical fibers comprises laser dicing of the immersed plurality of optical fibers proximate to the elastomeric fixture.

20. The method of claim 15, further comprising applying a mask over the diced ends of optical fibers of the plurality of optical fibers, wherein the selective applying of bonding material in interstitial spaces between optical fibers of the plurality of optical fibers proximate to the diced ends comprises applying bonding material through openings in the mask to produce the bundle-forming pattern of bonding material.

21. The method of claim 15, wherein the selective applying of bonding material in interstitial spaces between optical fibers of the plurality of optical fibers proximate to the diced ends comprises piezoelectric jetted printing of bonding material in the interstitial spaces to produce the bundle-forming pattern of bonding material.

22. The method of claim 15, wherein the bonding material comprises UV-curable adhesive material, and the curing of the bonding material selectively applied to the interstitial spaces comprises impinging UV emissions on the bonding material.

23. The method of claim 15, wherein:
the trunk fiber bundle comprises a trunk marker fiber along a perimeter of the trunk fiber bundle, with the trunk marker fiber comprising a marked coating at least at a location proximate to the trunk fiber ferrule, and with the trunk marker fiber being omitted from the plurality of breakout bundles; and
each breakout bundle of the plurality of breakout bundles comprises a breakout bundle marker optical fiber comprising a marked coating at least at a location proximate to the breakout connector end face, with the breakout bundle marker optical fiber being indicative of breakout bundle polarity.

24. The method of claim 15, wherein:
for each breakout bundle of the plurality of breakout bundles, the group of optical fibers is arranged in a hexagonal close-packed configuration or a rectangular close-packed configuration; and
the plurality of optical fibers of the trunk fiber bundle is arranged in a hexagonal close-packed configuration or a rectangular close-packed configuration.

25. The method of claim 15, comprising one of the following features (i) or (ii):
(i) optical fibers of the plurality of optical fibers comprise glass cladding surfaces in lateral contact with one another, or
(ii) each optical fiber of the plurality of optical fibers comprises a core, a cladding layer, and a hard coating layer having a Young's modulus greater than 100 MPa; and optical fibers of the plurality of optical fibers comprise hard coating layer surfaces in lateral contact with one another.
